(19) United States
(12) Patent Application Publication
(10) Pub. No.: US 2002/0091535 A1
(43) Pub. Date: Jul. 11, 2002

(54) System and method for selecting a vacation destination and accommodation

(75) Inventors: Robert Kendall, London (GB); Richard Duvall, Bucks (GB); Paul Simpson, London (GB)

Correspondence Address: David P. Gordon, Esq., 65 Woods End Road, Stamford, CT, 06905, US

(73) Assignee: GetInAction, Ltd

(21) Appl. No.: 09/757,020

(22) Filed: Jan. 8, 2001

(51) Int. Cl. G06F 17/60

(52) U.S. Cl. 705/1; 705/10; 705/5

(57) ABSTRACT

An interactive vacation destination selection system operates through a back and front ends. The back end identifies criteria which may be important to a consumer, and categorizes and assigns images to the criteria. The front end to the system assesses what a consumer wants in a vacation destination, identifies vacation destinations having the attributes that satisfy those wants, and then displays comparative data on those vacation destinations. By providing to the system basic information on the consumer and his or her travel companions, general information on how far the consumer is willing to travel, preferred weather conditions, a budget range, and the consumer's selection of criteria from one or more categories, the system is capable of determining a suitable vacation destination and accommodation for the consumer and the travel companions, even without being provided information on to where the consumer wants to travel.

### BACKGROUND OF THE INVENTION

1. Field of the Invention

This invention relates broadly to a system and method for data processing. More particularly, this invention relates to an interactive system and method to facilitate the selection of a vacation destination and accommodation by a consumer.

2. State of the Art

There are a number of options available to a consumer over the Internet to provide the consumer assistance in certain aspects of vacation (or holiday) planning. Some sites offer essays on numerous destinations. Wading through the available materials turns vacation planning into a research project. At the other extreme are online booking agent sites which locate airfares and hotels for a stated destination and then permit the consumer to book reservations. These online booking sites provide minimal assistance for the consumer who does not know where he or she wants to vacation or what kind of vacation he or she wants to have. Between the extremes exist myriad other sites which provide a range of services.

For example, several ‘personal advisor’ sites, e.g., www.allexperts.com and www.egulliver.com, provide specialists who correspond with consumers via email to provide suggestions on vacation destinations. The specialists are typically freelance travel consultants who help plan and arrange the travel. However, the response time is relatively slow and the recommendation is only as good as the individual specialist.

Other sites, e.g., www.personalogic.com, utilize a structured questionnaire in which consumers rate their preferences (e.g., from ‘strong’ to ‘weak’) on a number of vacation criteria. One of the preferences is to what general geographical destination the consumer wants to travel. The preferences are then extrapolated into recommendations. This analytical methodology provides unconvincing results and requires that the user already have an idea of to where he or she wants to travel.

Another category of sites are ‘activity led’ sites. These sites specialize in vacation packages or accommodations suited to one type of activity, such as golfing (e.g., www.golf-travel.com) or diving (e.g., www.diveguide.com). The sites generally either list their ‘best’ ranked resorts in which to perform the activity, or provide information on accommodations. Generally, no guidance is provided on which is the best vacation spot for any particular consumer. In addition, for those consumers who have not yet discovered that they would like a vacation centered around a particular activity, the sites do not provide any assistance; i.e., the web site will likely only be accessed once the consumer has determined on his or her own that he or she wishes to engage in a particular activity.

Directory sites, e.g., www.brochurebank.com and www.holidaywizard.co.uk, permit consumers to order print brochures from a range of travel operators. The brochures are then mailed to the consumer. While these sites permit a consumer access to information, they present several major limitations. First, no assistance is provided in requesting brochures. Second, there is a limitation on the number of brochures which can be requested. Third, there is a relatively large lag time for receipt of the brochures. Fourth, the consumer still has to sift through the information in the brochures and make a determination as to where he or she wants to travel.

Other sites, e.g., www.expedia.com and www.holidayswithease.co.uk., allow consumers to search for vacation packages, but are not suitable for consumers who have not yet determined to where they would like to travel; and as discussed above, all other sites require that the consumer know the general region in which he or she would like to travel or have a selected activity prior to choosing a destination. There is no site which interactively guides a consumer who does not generally know to where he or she wants to travel and what he or she want to do while on vacation.

### SUMMARY OF THE INVENTION

It is therefore an object of the invention to provide an interactive system which, based on interactive engagement with a consumer, selects a vacation destination for a consumer.

It is also an object of the invention to provide a method for interacting with a consumer and guiding a consumer in choosing vacation destinations.

It is another object of the invention to provide interactive vacation destination selection systems and methods which do not require the consumer to have prior knowledge of where he or she wishes to travel.

It is still another object of the invention to provide an interactive vacation destination selection system and method which inquire of the consumer a ‘type of vacation’ which the consumer desires.

It is a further object of the invention to provide an interactive vacation destination selection system and method, which based on the results of the ‘type of vacation’ inquiry, presents a plurality of categories each having associated attributes, the selection of the attributes within each category resulting in a selected vacation destination, as well as optional accommodations meeting the needs and wants of the consumer.

It is an additional object of the invention to provide an interactive vacation destination selection system in which the attributes are represented by images, and the images, in total, operate to summarize the consumer's desired vacation.

In accord with these objects, which will be discussed in detail below, an interactive vacation destination selection system is provided which guides a consumer in choosing where the consumer wants to travel. The vacation destination selection system operates through a back end and a front end. The back end identifies criteria which may be important to a consumer, categorizes the criteria, and assigns images to the criteria. In addition, the back end collects data (or attributes) on various vacation destinations serviced by the system and assigns the attributes to the appropriate criteria. The front end to the system assesses what a consumer wants in his or her vacation destination, identifies vacation destinations having the attributes that satisfy those wants, and then displays comparative data on those vacation destinations.

The consumer inputs his or her personal data (e.g., number of travelers, ages of travelers, when the consumer wants to travel, the length of the vacation, the distance from home the consumer is willing to travel, and a budget range), as well as a vacation category; that is, the vacation defined in broad terms (e.g., cruise, sun and beach, activity led, countryside, safari, etc.) into the front end of the system. The front end then displays to the user criteria related to the category and selected from the back end data. Each criterion is preferably represented by an image, and the consumer is able to select one or more of the images to identify the consumer's criteria. The images selected are displayed for the user and together provide a visual representation of the type of vacation being sought by the user. The system compares the consumer's input personal data and selected vacation category, as well as criteria related to that category, with the attributes of all vacation destinations in the back end of the system. The system then identifies vacation destinations which satisfy the consumer's vacation wants (based on the selected criteria) and provides to the consumer a detailed objective comparison of vacation destinations having attributes which meet the consumer's selected criteria. It will be appreciated that the system is capable of determining a suitable vacation destination for a consumer even without being provided information as to where the consumer wants to travel.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic of the interactive vacation destination selection system according to the invention;

FIG. 2A through 2D together constitute a flow chart illustrating the method of operation of the vacation destination selection system of the invention; and

FIGS. 3 through 19 are exemplar ‘screen shots’ of the front end interface of the vacation destination selection system.

### DETAILED DESCRIPTION OF THE PREFERRED EMBODIMENTS

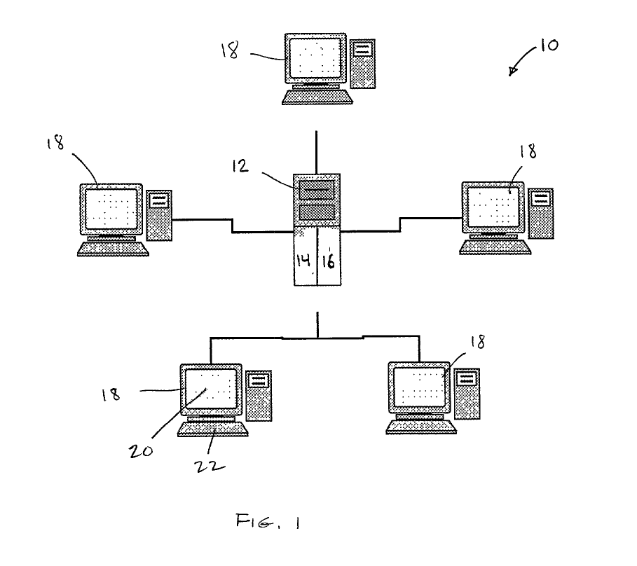

Turning now to FIG. 1, according to the invention, a vacation (or holiday) destination selection system 10 includes a central computer 12 operating a back end data module 14 and a front end interface module 16. The back end module may be implemented as a database of criteria and attributes, as described below, and the front end module may be implemented as a database of HTML (hypertext markup language) files and associated image files which, as also described below, facilitate user interaction with the system. The central computer 12 is in communication with one or more user terminals 18 (e.g., home computers) via the Internet or other computer network. That is, the central computer is preferably a server 12, and the terminals 18 are preferably nodes on the network. The terminals 18 include a display 20 which permits a consumer (user) to view the HTML and image files of the front end module 16 of a remotely located central computer 12, and an input device 22 (e.g., a keyboard, mouse, and/or microphone) which permits the consumer the provide input to the computer 12.

The back end module 14 includes criteria, described in more detail below, which may be important to a consumer in selecting a vacation destination, and which are organized into categories appropriate for the type of vacation and general location selected. Exemplar categories for a beach vacation include: ‘destinations’, ‘local area’, ‘accommodations’, ‘important for kids’, ‘things to do’, and ‘individual needs’, which are described in more detail below.

In addition, data (or attributes) collected on various vacation destinations and accommodations serviced by the system are stored in the back end module and assigned to the appropriate criteria. Attribute includes, with respect to particular destinations and accommodations, the cost, the particular activities offered, features of the locality, food options, etc. For example, if a particular modern hotel located on the beach has both a luxury and standard rooms and a pool, and is located just outside a historic village and also has access to various water sports including sailing and snorkeling, the hotel will be linked with the relevant criteria in the relevant categories:

‘accommodations’: ‘hotel’, ‘modern’, ‘on the beach’, ‘luxury’, ‘standard’, ‘pool’;

‘local area’: ‘historic’;

‘things to do’: ‘sailing’, ‘snorkeling’.

According to a preferred aspect of the invention, image files are also assigned to each of the criterion within a category. The associated image file may change based upon a consumer's selection of other criteria. The front and back end modules of the system assess what a consumer wants in his or her vacation destination (based on the consumer's input at the terminal), identifies vacation destinations and accommodations having the attributes that satisfy those wants, and then displays on the terminal comparative data on those vacation destinations and accommodations.

The front end interface module 16 provides an interactive interface which guides the consumer through the selection of criteria desired for a vacation. Then, as described in more detail below, once the criteria have been selected by the consumer, destinations and accommodation having attributes which best meet the wants of the consumer are presented to the consumer for final review by the consumer.

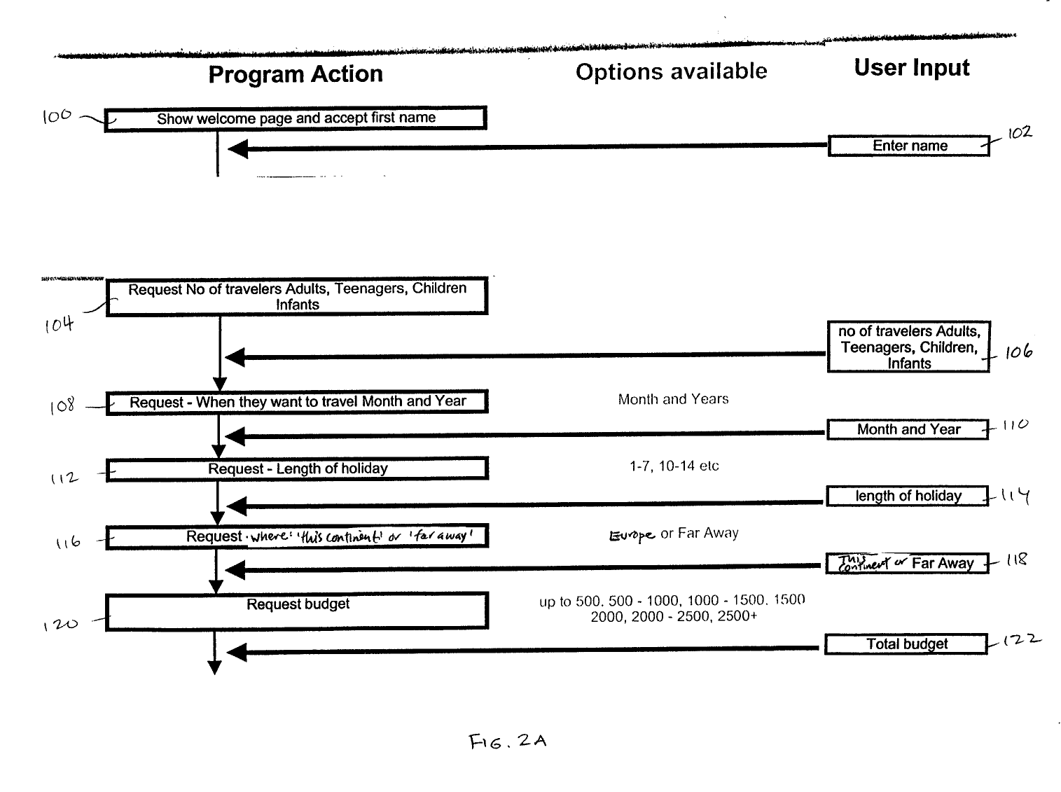

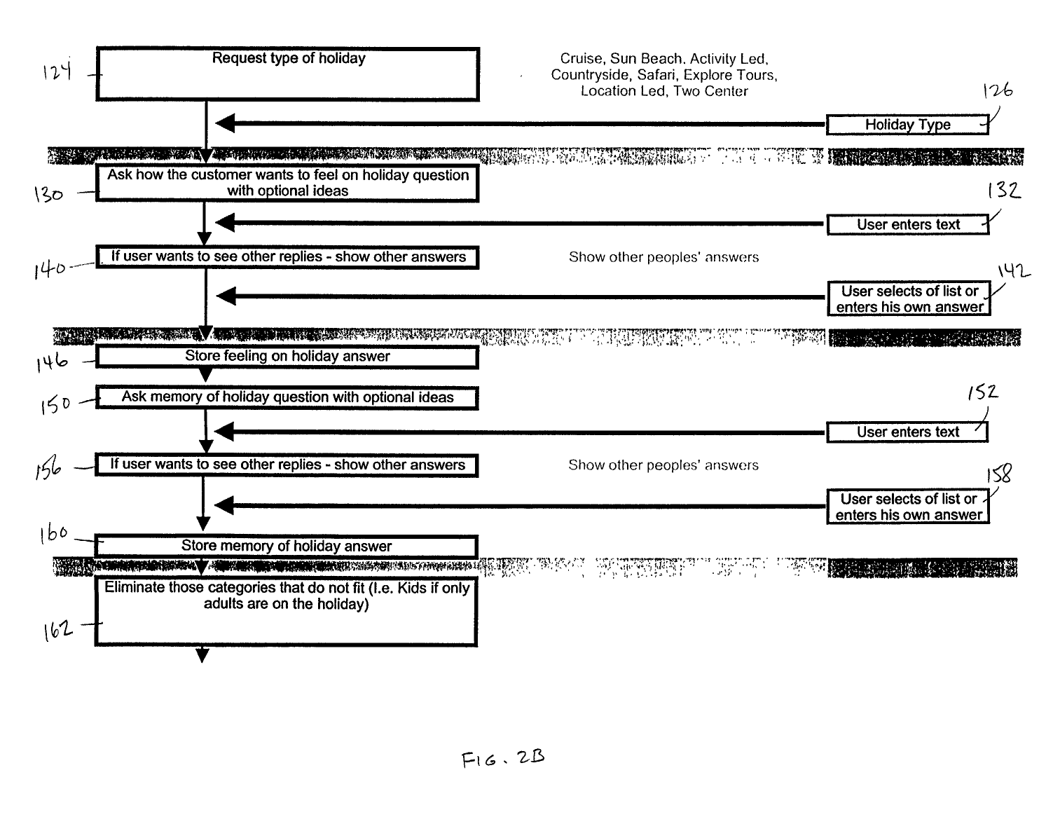

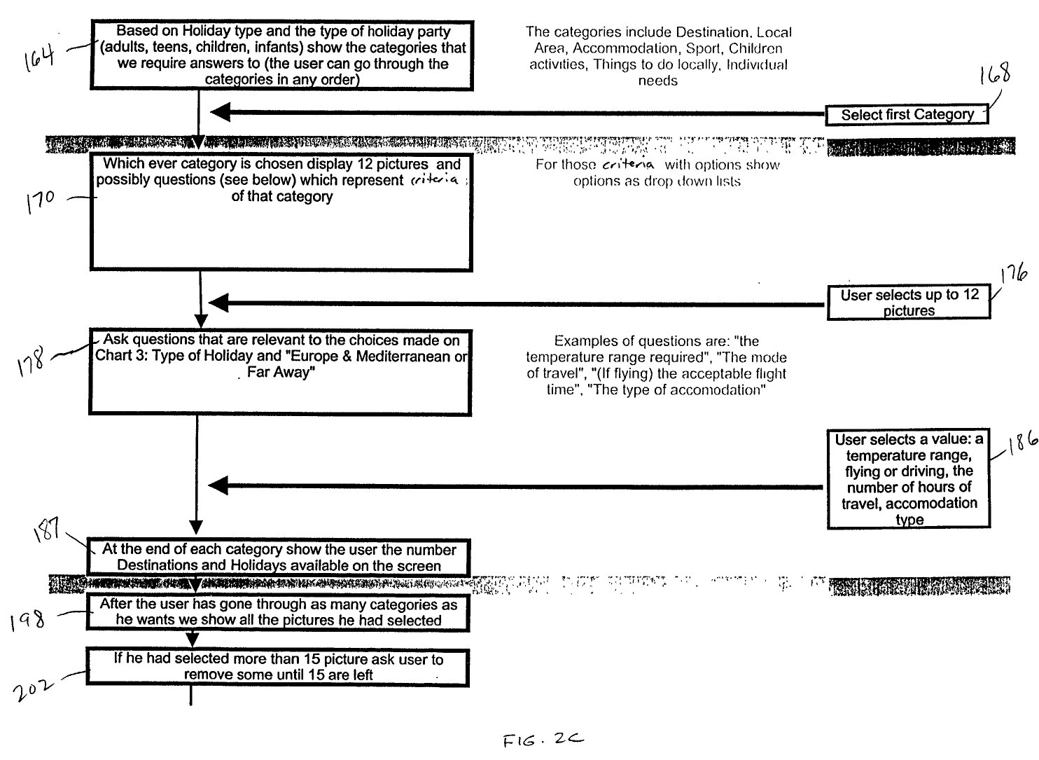

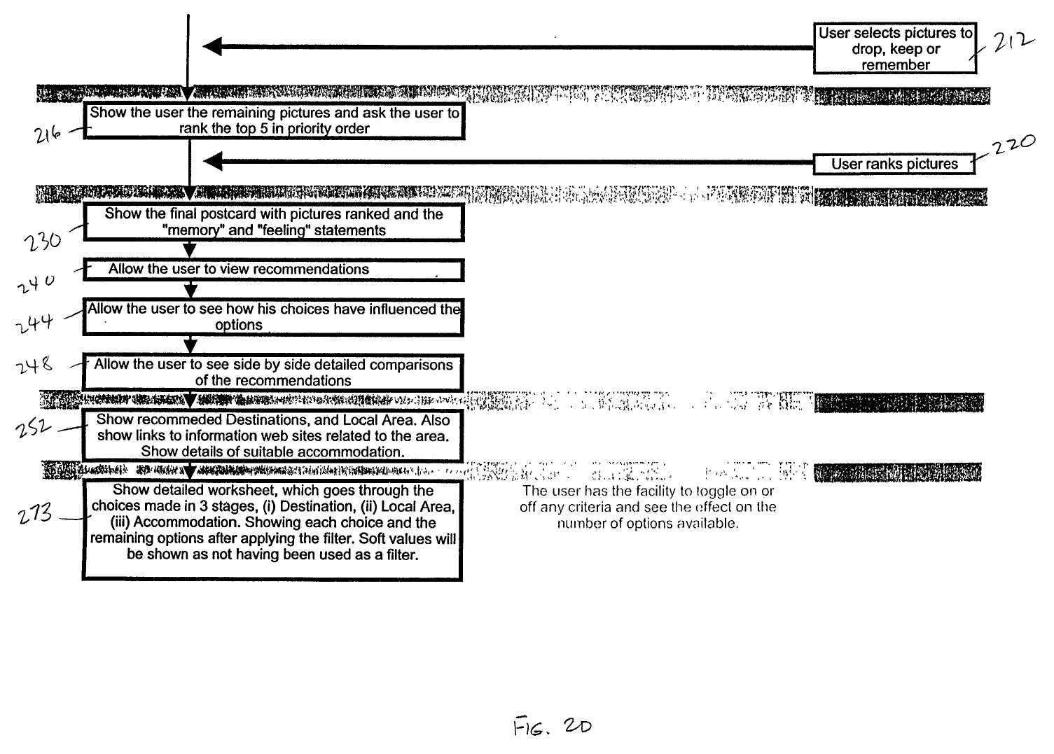

Referring to FIG. 2A, the front end module first requests that the consumer supply information as to who will be traveling; i.e., who (the name of the consumer inputting the requested information) at 100 and the number of travelers and their age ranges (the number of adults, the number of teenagers, the number of children, the number of infants) at 104. The consumer responds by entering the requested information at 102 and 106. The consumer is also requested to input when he or she wants to travel at 108 (and responds with a month and year at 110), for how long at 112 (and responds by selection of a time period 1-7 days, 10-14 days, etc. at 114), how far away at 116 (and responds with ‘this continent’ or ‘far away’ at 118), and a budget range at 120 (and responds with a range of per person costs of up to $500, $500-$1000, $1000-$1500, $1500-$2000, $2000-$2500, and greater than $2500 at 122). Each of the consumer responses 110, 114, 118, 122 is stored by the computer.

Referring to FIG. 2B, the front end module additionally requests the consumer to provide at 124 an indication of the general type of vacation that the consumer is seeking, e.g., cruise, sun and beach, activity led, countryside, safari, exploration tour, multiple locations, etc. The consumer's response to the request is provided at 126 and then stored. All the above responses, other than the consumer name at 102, are preferably input by the consumer via selection of appropriate check boxes or selection of items from pull down lists.

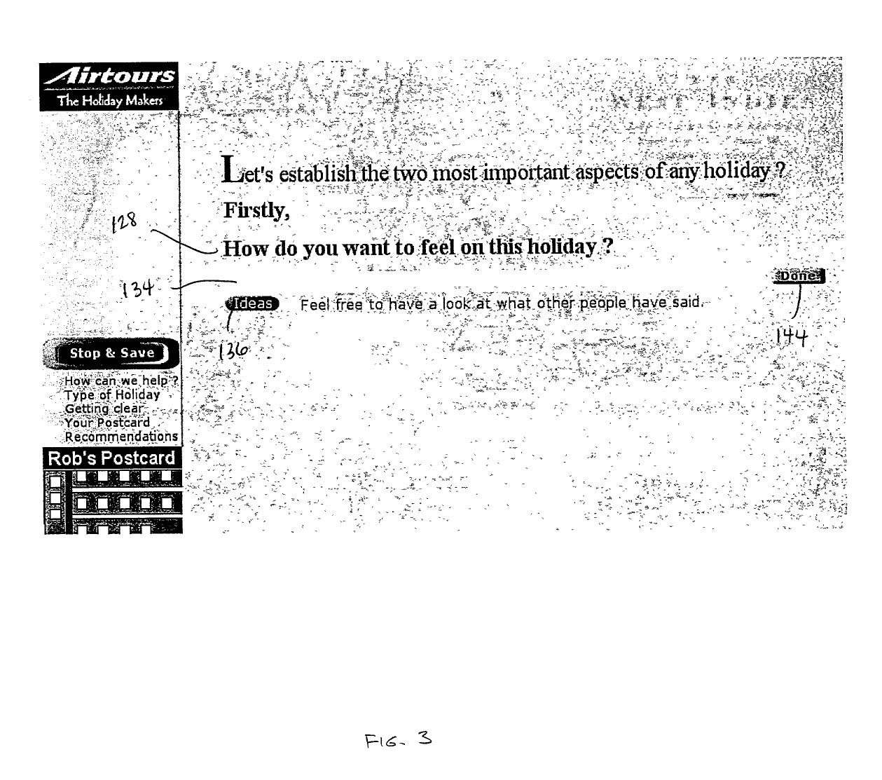

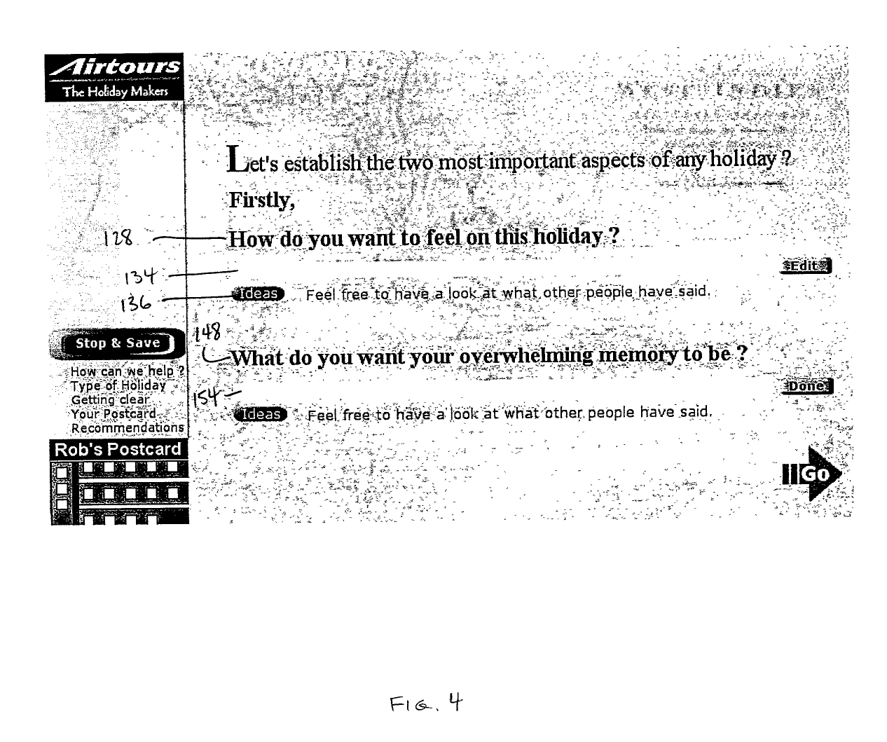

Then, referring now to FIGS. 2B and 3, the front end preferably, though optionally, presents one or more questions to focus the consumer on what he or she wants to achieve on the vacation. A first question 128 presented at 130 is preferably “How do you want to feel on your vacation?”. The consumer enters at 132 his or her typed answer, in their own words, in a text box 134. An ‘ideas button’ 136 is also provided to give the consumer the option at 140 to view previously stored responses of others in order to help formulate the consumer's own answer. The consumer may at 142 select one of the previously stored responses as his or her own answer as an alternative to typing his or her own response. After the user has entered or selected his or her answer, a ‘done’ button 144 is activated to store at 146 the answer. Referring to FIGS. 2B and 4, a second question 148 “What do you want your overwhelming memory to be?” is presented at 150. The consumer may enter his or her own answer at 152 in a text box 154, or view, at 156, and select at 158 the answer of another. The answer is then stored at 160. The stored answers are used in a postcard file, described below, and for access by others seeking to formulate their own responses.

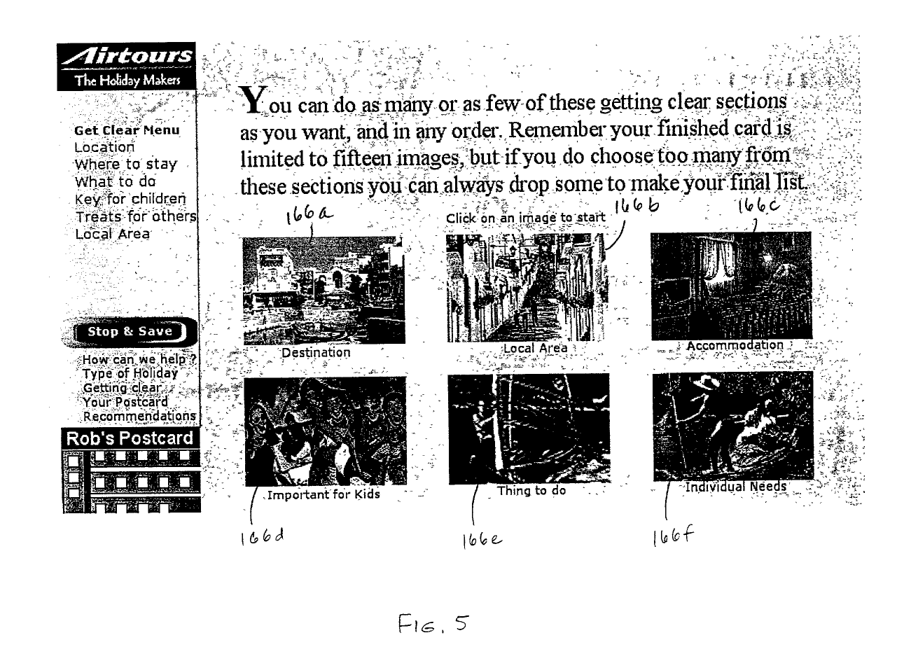

Based upon the consumer's previous responses, criteria (organized in categories) designed to elicit more particular information from the consumer are prepared for presentation to the user. Referring now to FIG. 2B, if any one or more categories from the standard category set (‘destination’, ‘local area’, ‘accommodations’, ‘important for kids’, ‘things to do’ and ‘individual needs’) are not appropriate in view of the previous responses by the consumer, the category of criteria may be eliminated at 162. For example, if no children are traveling, the ‘important for kids’ category is preferably eliminated for that consumer. Then, referring to FIGS. 2C and 5, based on the type of vacation earlier selected by the consumer (e.g., ‘beach and sun’) and the age of the travelers (e.g., adults and children), the system displays at 164 on the terminal the remaining categories 166a, 166b, 166c, 166d, 166e, 166f from the standard category set such that the consumer may provide information in order to most appropriately select a vacation destination.

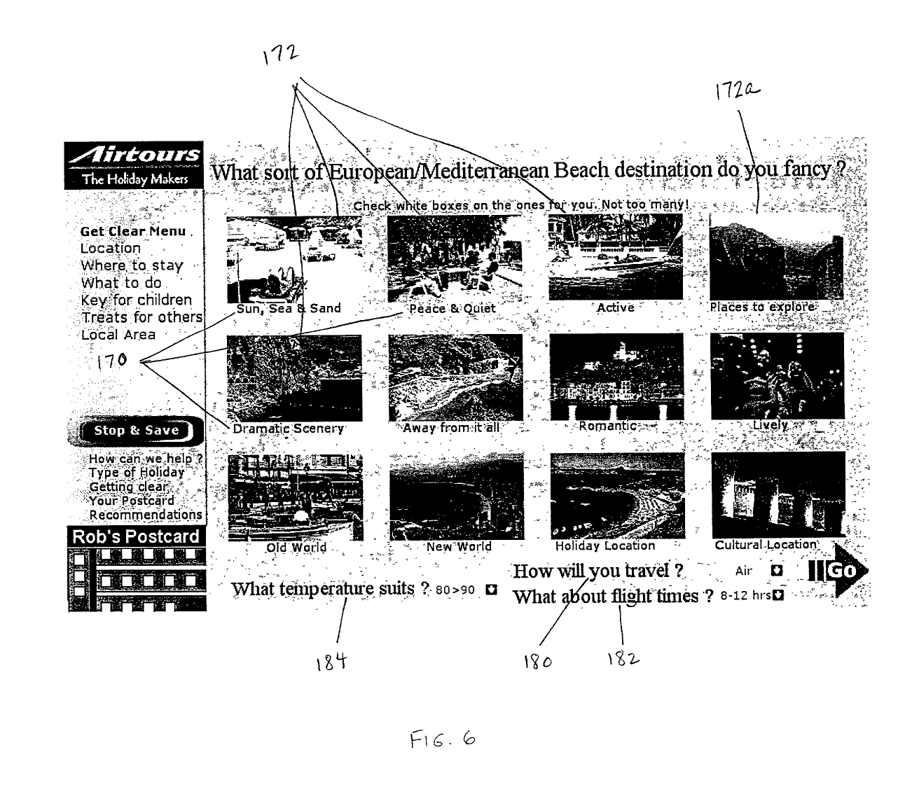

The consumer may select any of the categories 166a-f to provide information in any order. Selection at 168 of any of the categories 166a-f brings up appropriate criteria by which the consumer can more particularly define what he or she wants to experience on the vacation. Referring to FIG. 6, preferably twelve criteria 170 and associated image files 172 are displayed in a two-dimensional array at 174 for each category. While each criteria has an associated image file, the image files do not refer to particular destinations, accommodations, etc., but rather are intended to convey a feeling which the consumer is trying to achieve on the vacation by selection of the criteria. For example, if a European consumer previously indicated that she wants a European or Mediterranean beach vacation and selects the category of ‘destination’ 166a, preferably twelve criteria are presented to the consumer; for example, ‘sun, sea and sand’, ‘peace and quiet’, ‘active’, ‘places to explore’, ‘dramatic scenery’, ‘away from it all’, ‘romantic’, ‘lively’, ‘old world’, ‘new world’, ‘holiday location’, and ‘cultural location’. The consumer may select at 176 none, one, or more (up to all twelve) of the criteria (by marking check boxes) which best reflect how they want to experience their vacation. The selected criteria are added to a postcard’ file, which is described in more detail below. In addition, several questions (or options) are presented at 178 to the consumer regarding the mode of travel (air, water, land) 180, the distance willing to travel (in travel time) 182, and the weather of the destination (temperature and/or rainfall) 184. The responses to these questions at 186 also constitute criteria and are stored.

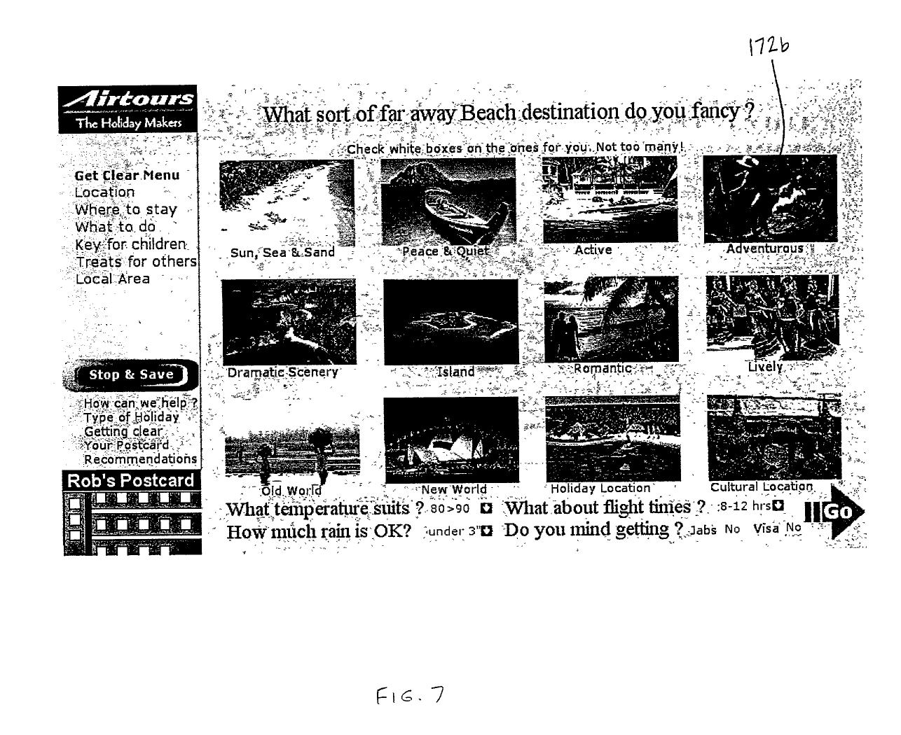

By way of another example, if another European consumer previously indicated that he wants a far away beach vacation and is traveling without children, the selection of the ‘destination’ category will bring up criteria which may differ from the example above; for example, ‘adventurous’ 172b (FIG. 7) replaces ‘places to explore’ 172a (FIG. 6).

Referring back to FIG. 2C, after the consumer makes his or her criteria selections in each category in which he or she desires to provide a criteria selection, the system preferably displays at 187 to the user the number of vacation destinations/accommodations remaining in the system that meet the selected criteria.

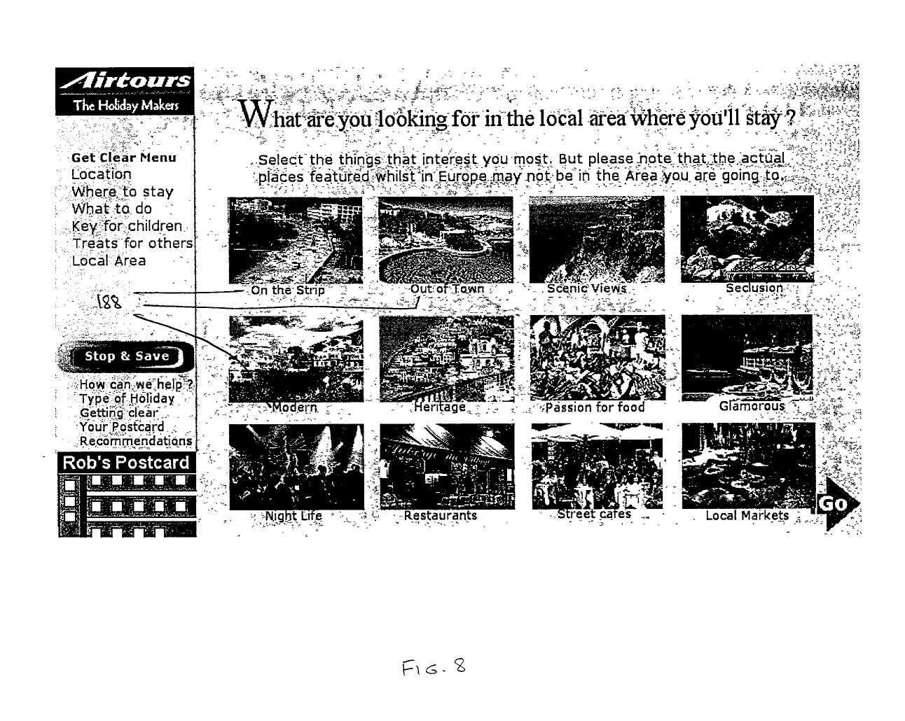

The consumer may then select criteria from one of the remaining categories shown in FIG. 5. Turning now to FIG. 8, if the category of ‘local area’ 166b is chosen next, exemplar criteria 188 for selection by the consumer may include: ‘on the strip’, ‘out of town’, ‘scenic views’, ‘seclusion’, ‘modern’, ‘heritage’, ‘passion for food’, ‘glamorous’, ‘night life’, ‘restaurants’, ‘street cafes’, ‘local markets’.

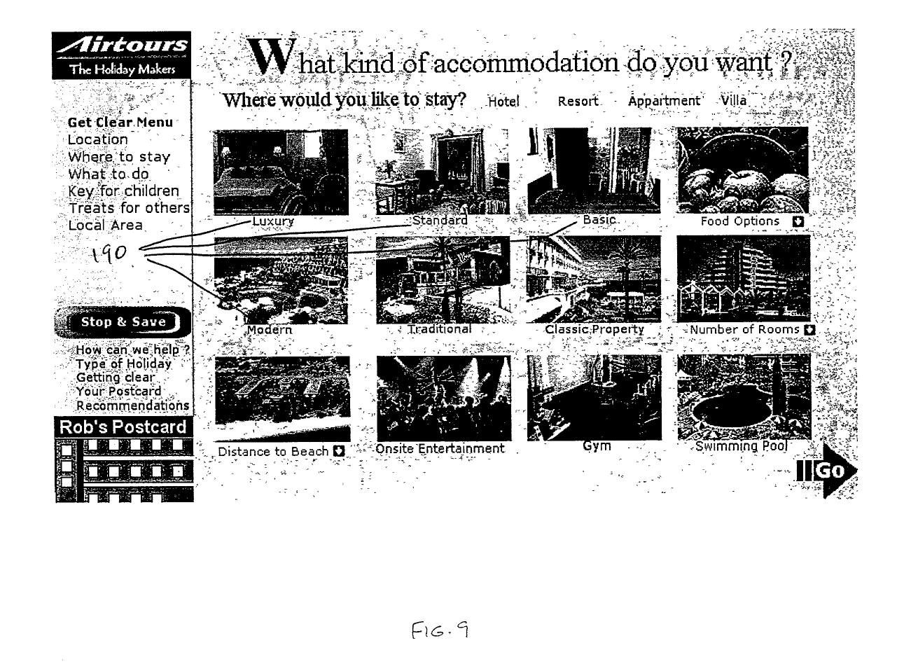

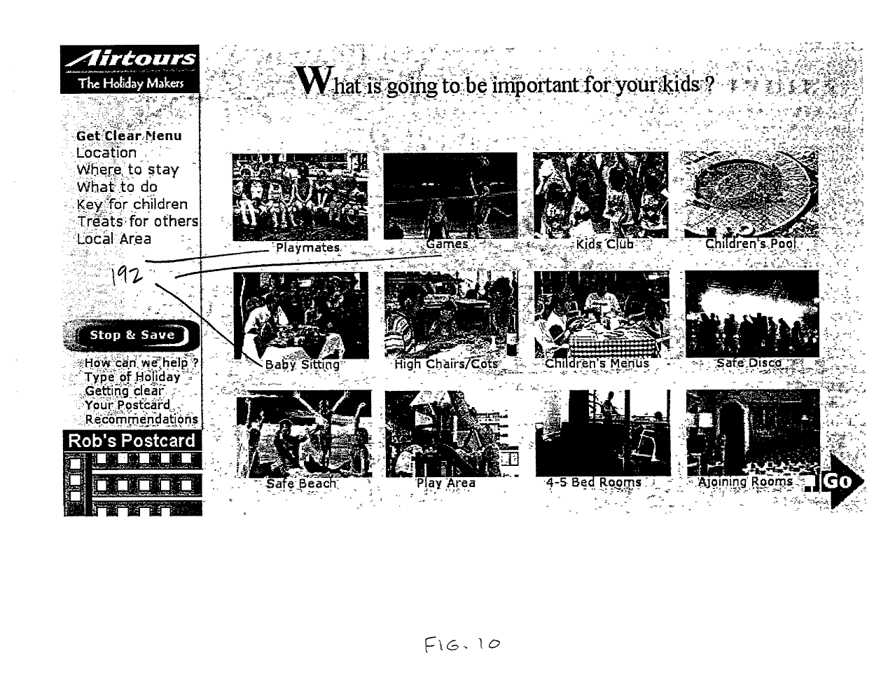

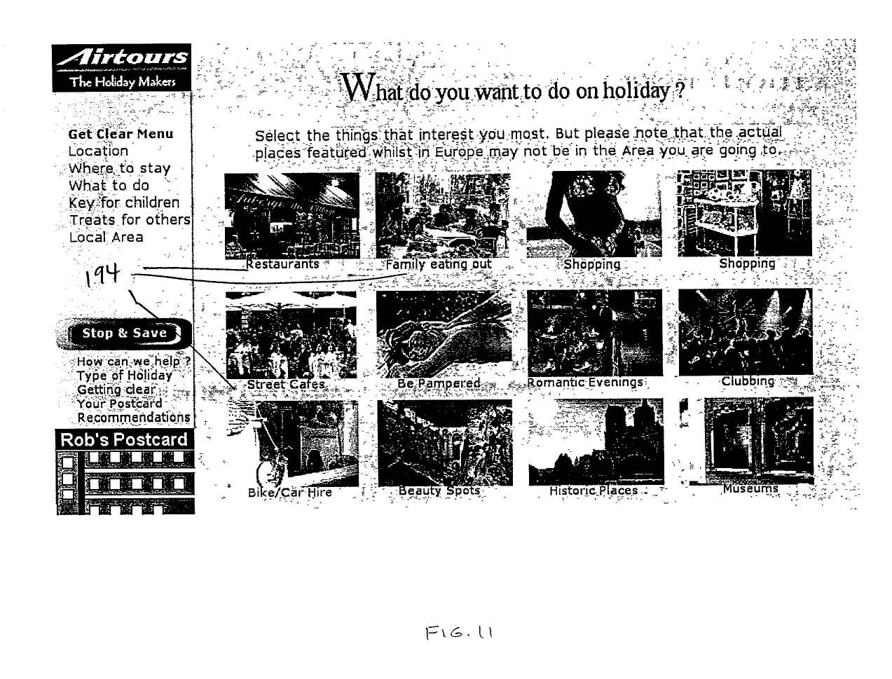

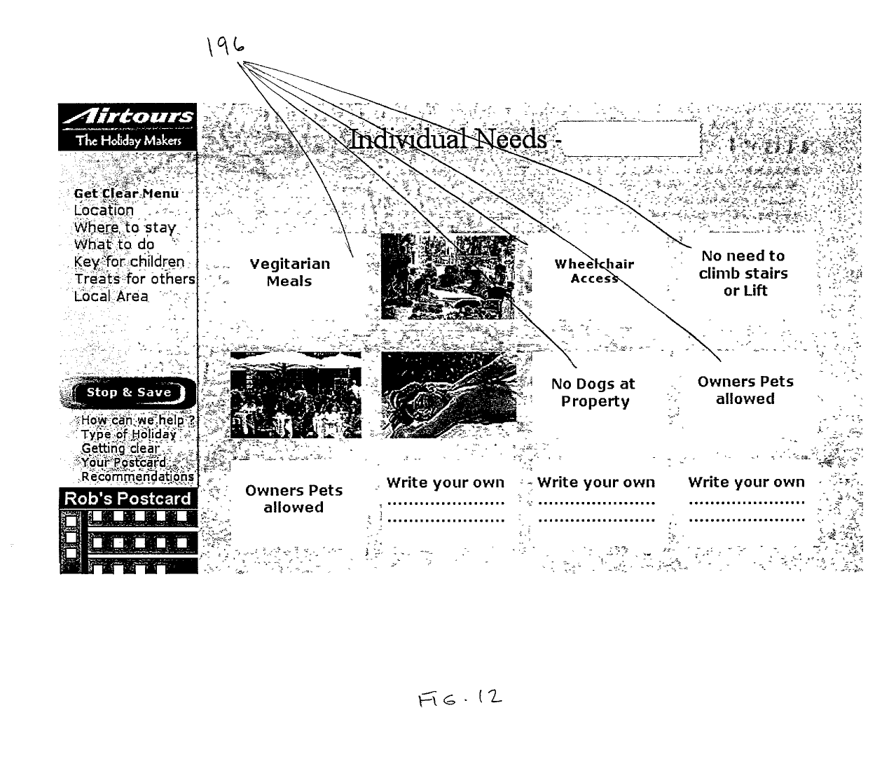

The consumer then selects criteria from another category. For example, referring to FIG. 9, with respect to ‘accommodation’, exemplar criteria 190 include: ‘hotel’, ‘resort’, ‘apartment’, ‘villa’, ‘luxury’, ‘standard’, ‘basic’, ‘modern’, ‘traditional’, ‘classic property’, ‘onsite entertainment’, ‘gym’, ‘swimming pool’, ‘distance to beach’, ‘food options’, and ‘number of rooms’. With respect to ‘distance to beach’, ‘food options’, and ‘number of rooms’, options may be selected from a drop down list. Criteria are selected, and the associated images are added to the image postcard. Referring to FIG. 10, with respect to the category of ‘important for kids’, exemplar criteria 192 include: ‘playmates’, ‘games’, ‘kids clubs’, ‘children's pool’, ‘baby sitting’, ‘high chairs/cots’, ‘children's menus’, ‘safe disco’, ‘safe beach’, ‘play area’, ‘4-5 bedrooms’, and ‘adjoining rooms’. Referring to FIG. 11, with respect to the category of ‘activities’, exemplar criteria 194 include: ‘restaurants’, ‘family eating out’, ‘shopping’, ‘street cafes’, ‘being pampered’, ‘romantic evenings’, ‘clubbing’, ‘bike/car hire’, ‘beauty spots’, ‘historic places’, ‘museums’. Referring to FIG. 12, with respect to the category of ‘individual needs’, exemplar criteria 196 include: ‘vegetarian meals’, ‘wheelchair access’, ‘lift’ (or elevator), ‘no dogs’, ‘pets allowed’. The criteria in each category are reviewed by the consumer and desirable criteria are selected, In addition, while not shown, the consumer may add his or her own criteria. The selected criteria and the associated image files are stored in the postcard file.

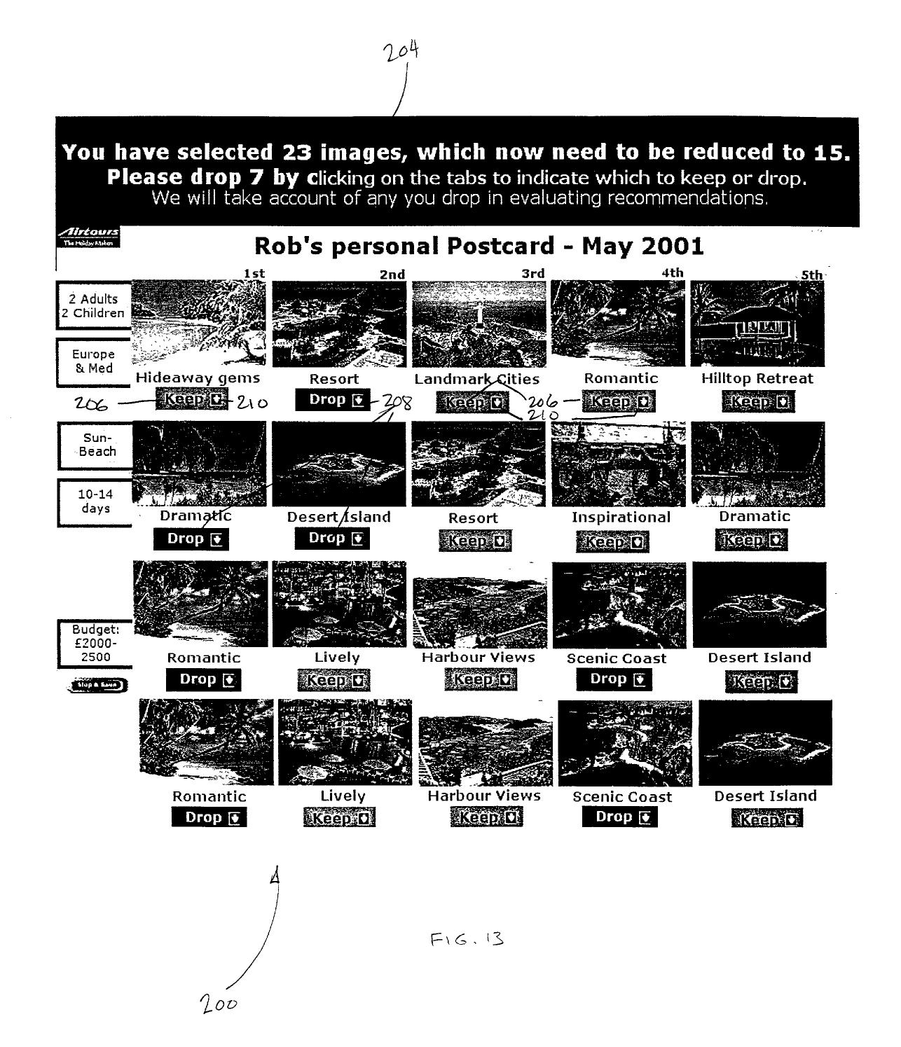

After the consumer has completed review of the categories and made his or her selection of desired criteria, the consumer is presented at 198 with a preliminary postcard file 200, as shown in FIG. 13. The preliminary postcard file 200 is a two-dimensional array of the selected criteria and images associated with the selected criteria. If the consumer has selected more criteria than a set maximum number, e.g., fifteen criteria, the consumer is preferably requested at 202 (FIG. 2C), 204 (FIG. 13) to select which criteria to ‘keep’ and which criteria to ‘drop’ to bring the number within the maximum number. When required, the consumer indicates which criteria to ‘keep’ or ‘drop’ by selection of ‘keep’ 206 and ‘drop’ 208 from a drop down list 210 associated with each criteria. ‘Dropped’ criteria are nevertheless preferably taken into account in evaluating vacation destination recommendations for a consumer. Alternatively, three options may be provided: ‘keep’, ‘drop’, and ‘remember’, in which ‘dropped’ criteria are not later taken in to account, and ‘remembered’ criteria are taken into account but given lesser weight than ‘kept’ criteria.

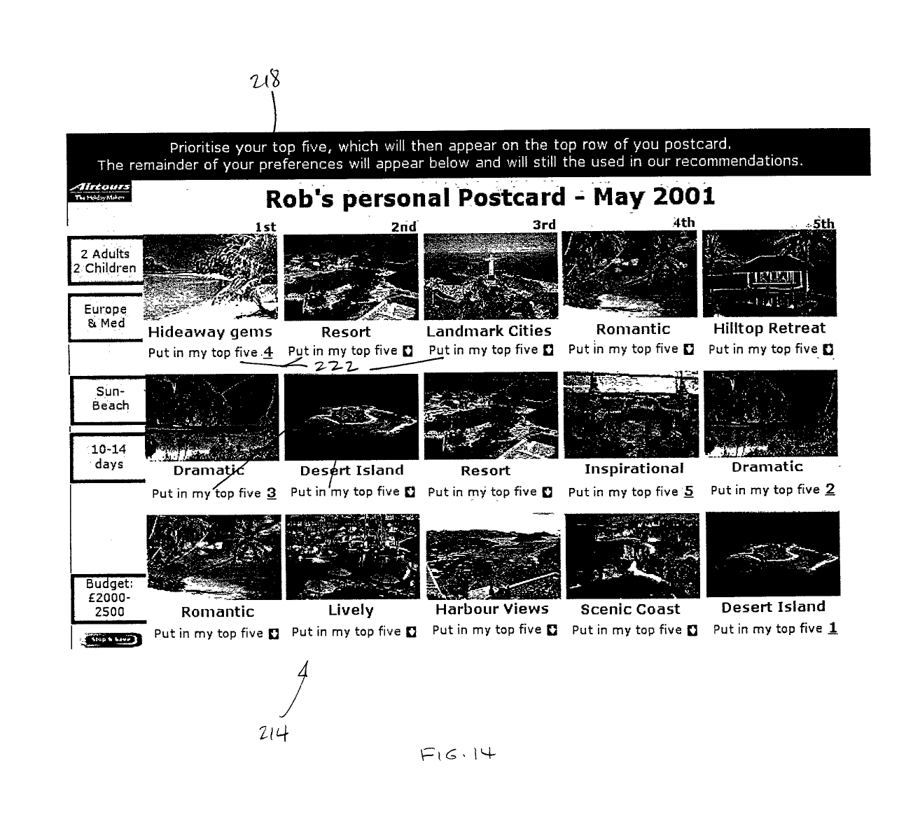

Referring to FIGS. 2D and 14, once the consumer has reduced at 212 the number of criteria to within the maximum number, the consumer is presented with an updated preliminary postcard file 214 at 216. The consumer is then preferably requested, at 216 (FIG. 2D) and 218 (FIG. 218), to prioritize the remaining criteria by ranking the several, e.g., five, most important criteria to the consumer. The consumer ranks at 220 the most important criteria preferably with a pull down list 222 under each of the remaining criteria. This operates to weight the ranked criteria more heavily in the selection process, but preferably does not operate to eliminate the other criteria in the updated preliminary postcard file as factors in the selection process.

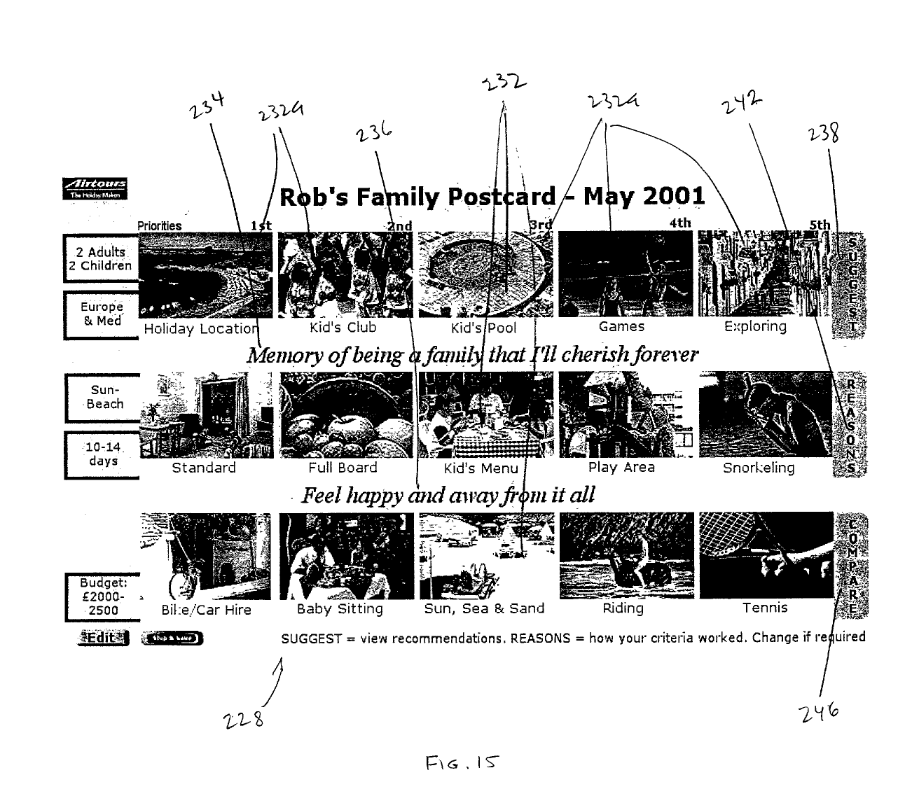

After the criteria have been ranked by the consumer, the system makes a determination of which vacation destinations most meet the needs of the consumer. This is done by comparing the attributes of the vacation destination in the system with the criteria of the consumer taking into account the consumer's weighted ranking of the most important criteria. In addition, referring to FIGS. 2D and 15, a final postcard file 228 is prepared and displayed at 230 for the consumer. The final postcard file 228 includes the criteria names and associated image files for the ‘kept’ criteria 232, with the top-ranked criteria 232a displayed most prominently, e.g., across the top of the postcard. In addition, the final postcard file includes the consumer's responses 234, 236 to the initial questions of “How do you want to feel on your vacation?” and “What do you want your overwhelming memory to be”?; i.e., the responses stored at 146, 160. In addition, the postcard file includes a link (or hyperlink) 238 to a display of the recommended vacation destinations (which can be selected at 240), a link 242 to a list of the reasons for the recommendations (which can be selected at 244), and a link 246 to side-by-side comparisons of the recommendations (which can be selected at 248).

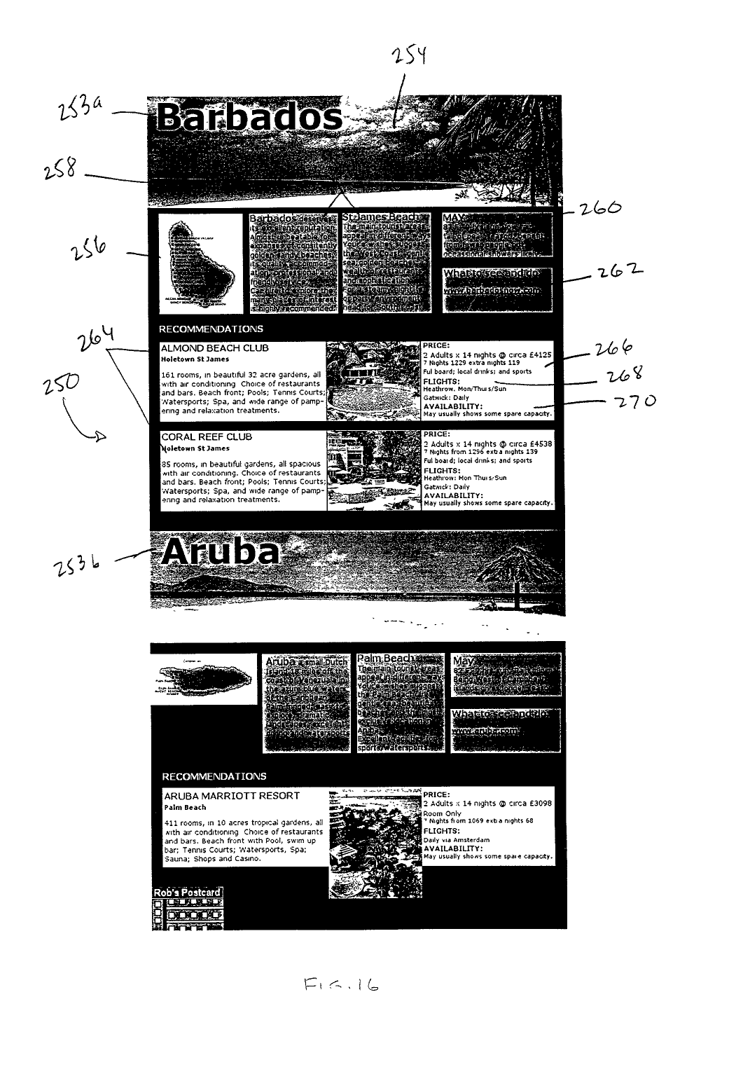

If the consumer selects the link 238 to the display of the recommended vacation destinations, a display 250 such as shown in FIG. 16 is provided at 252 to the consumer. The display 250 preferably includes for each vacation destination 253a, 253b, a photograph 254, a map 256, basic information on the locale 258, the weather 260, a URL (uniform resource locator) hyperlink to more information 262, recommended accommodations 264, prices 266, access 268, and availability 270.

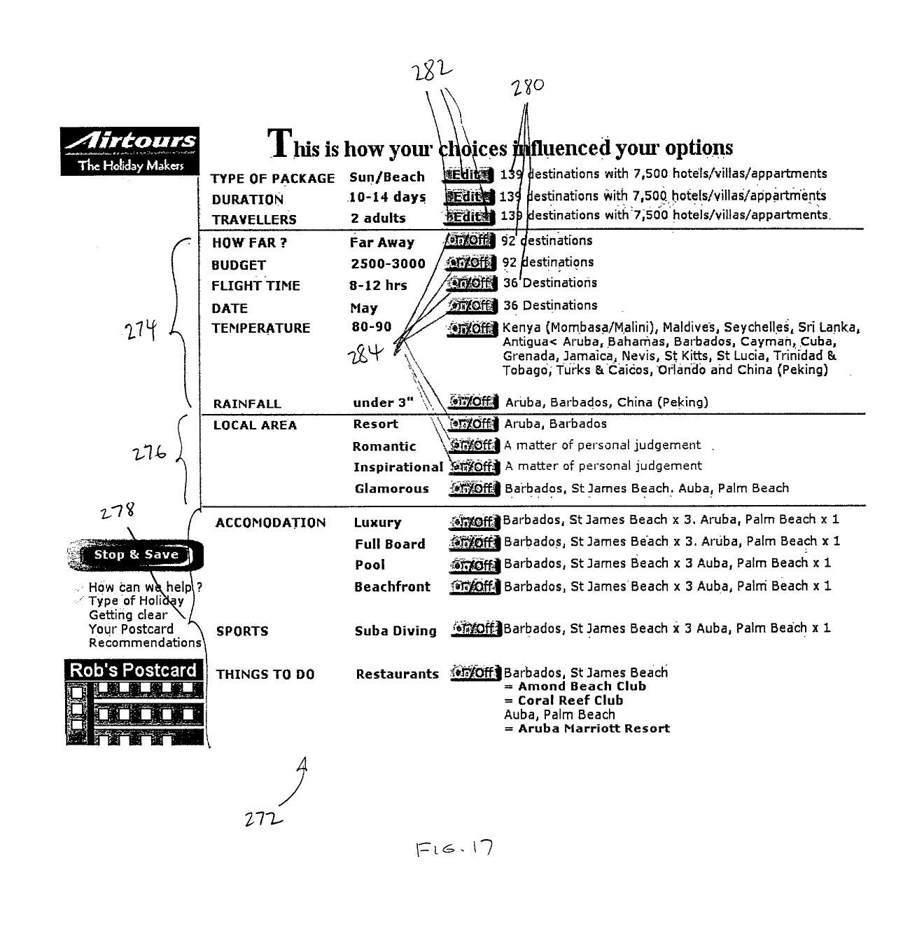

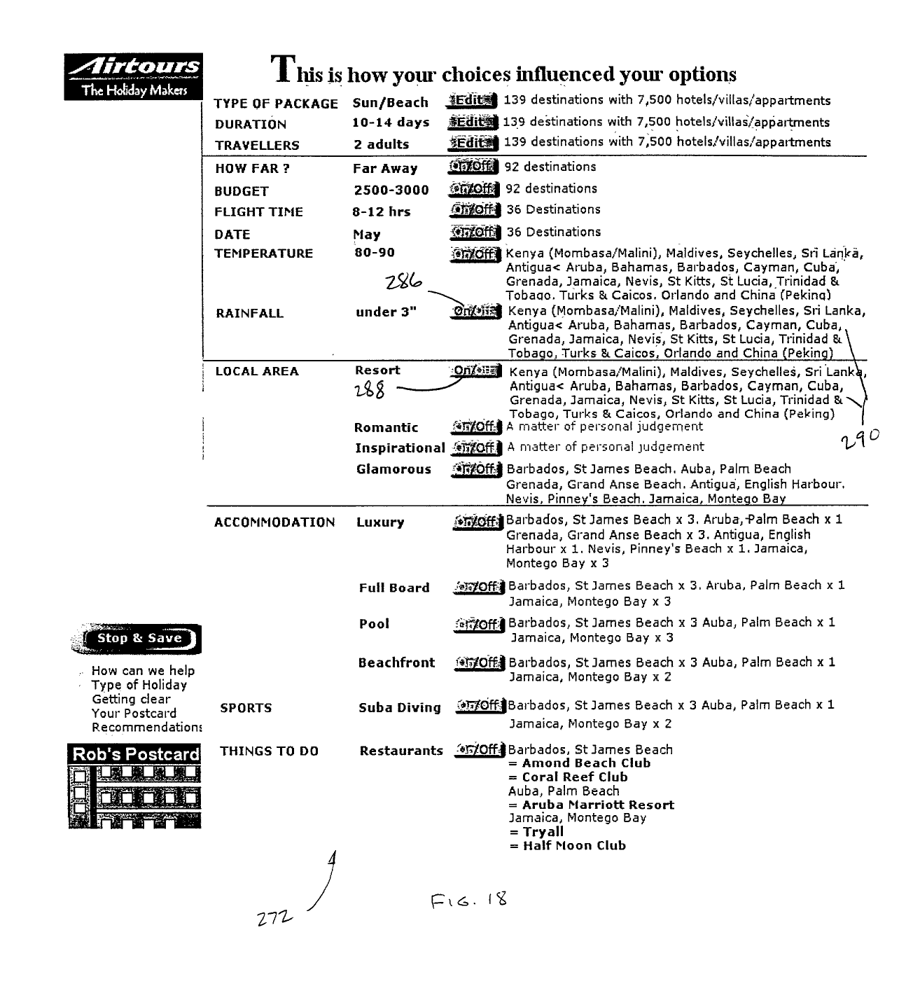

If the consumer selects the link to the list of the reasons for the recommendations, a worksheet 272 such as shown in FIG. 17 is provided at 273 to the consumer. The worksheet 272 indicates the choices made with respect to the ‘destination’ 274, ‘local area’ 276, and ‘accommodation’ categories 278. The worksheet displays the number of destinations remaining 280 after each criteria selection by the consumer. The consumer is able to edit, via selection of ‘edit’ buttons 282 and ‘on/off’ buttons 284 the reasons and see how such changes affect the recommendations. For example, FIG. 18, the worksheet 272 indicates that by changing various criteria (permitting greater rainfall at 286 and not limiting the accommodation to a resort at 288) additional recommendations 290 for a vacation destination are made by the system. Throughout the interactive selection process the number of possible options which satisfy the selection criteria are shown thereby ensuring the consumer can see the number of remaining options.

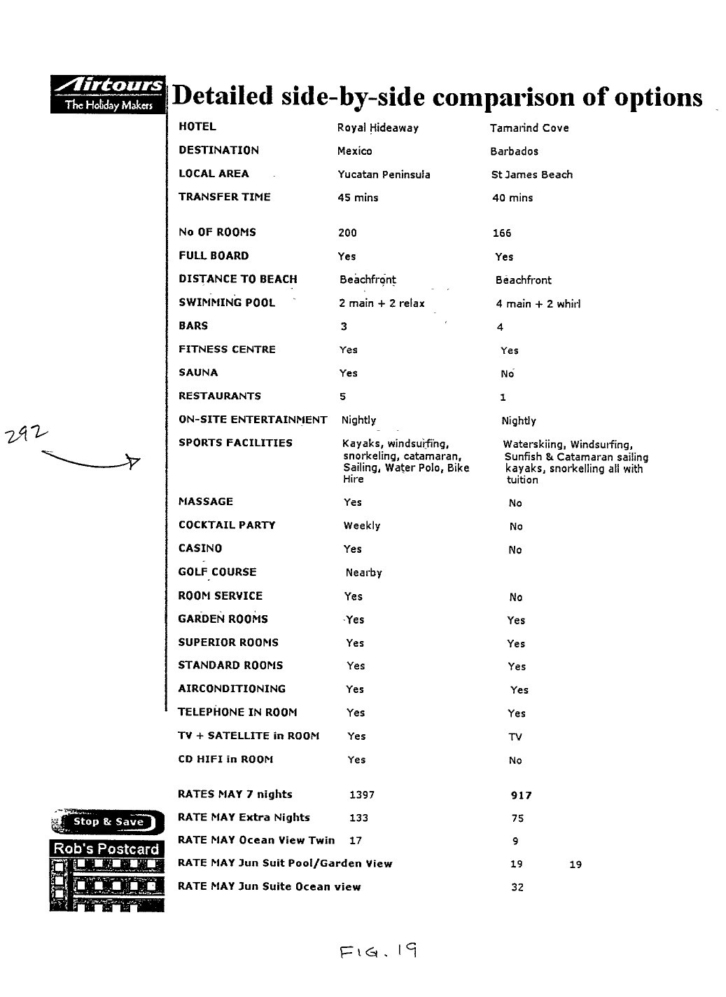

FIG. 19 displays the side-by-side comparisons 292 of the recommendations, permitting the consumer to analyze in detail various details of the recommendation (e.g., size of the accommodations, full board options, distance to beach, number of swimming pools, restaurants and bars, whether the accommodations have a fitness center, sauna, casino, or golf course, etc.) to facilitate making a final choice. Finally, the consumer may select one of the recommended vacation packages for purchase. To facilitate the purchase, a referral link may be provided to an online ticket and hotel booking service, a phone number for a travel agency may be provided, or the front and back end modules may include the necessary forms and data, which are known in the art, to complete the transaction.

By providing basic information on the travelers, and general information on how far the travelers are willing to travel, the preferred weather conditions, a budget range, and the selection of criteria from one or more categories, the system 10 is capable of determining a suitable vacation destination, even without being provided information as to where the consumer wants to travel.

There has been described and illustrated herein an embodiment of an interactive system for the selection of a vacation destination and a method of selecting a vacation destination. While a particular embodiments of the invention has been described, it is not intended that the invention be limited thereto, as it is intended that the invention be as broad in scope as the art will allow and that the specification be read likewise. Thus, while the consumer is presented with a number of categories from which to choose criteria, the consumer does not need to review the criteria in all the categories; an appropriate selection of a vacation destination may nevertheless be made by the system, provided that criteria in a non-reviewed category are not essential to the consumer's enjoyment of the vacation. In addition, while particular criteria have been disclosed for use within the various categories, it will be appreciated that other categories, e.g., sports available, and other criteria within the disclosed categories may be used as well. Furthermore, while the vacation destination selection system is preferably implemented with a global computer network, it will be appreciated that the system may also be implemented in another interactive medium, for example, an in-travel agency kiosk, portable digital media, e.g., CD-ROMs and DVDs, or via interactive television, such that a stand-alone (non-networked) computer system or television is utilized to implement the system. Moreover, while a front end module and back end module are discussed as distinct databases, it will be appreciated that the modules may operate as portions of a common database. In addition, while two preferred focus questions are disclosed for preferable presentation to the consumer, other or additional questions may be used. Moreover, while the focus questions are intended to aid in consumer selection of criteria as well as be displayed on the postcard, it will be appreciated that a natural language parser may be used to incorporate the response into the vacation destination selection process. Also, while the front end is preferably implemented in a series of HTML files, it will be appreciated that other file types (e.g., VRML, JAVA applets, etc.) may also be used to implement the front end. It will therefore be appreciated by those skilled in the art that yet other modifications could be made to the provided invention without deviating from its spirit and scope as claimed.

1. An interactive vacation destination selection system, comprising:
a) a computer including data files and user interface files, the data files including vacation criteria and attributes from a plurality of vacation destinations, said attributes being assigned to one or more of said vacation criteria;
b) a terminal in communication with said computer;
c) a display; and
d) a user input device,
said terminal adapted to receive said user interface files and said vacation criteria from said computer and to display said user interface file and said vacation criteria on said display,
wherein upon selection via the user input device of a plurality of said displayed vacation criteria, said computer provides a recommendation of at least one vacation destination which is displayed on said display of said terminal.

2. An interactive vacation destination selection system according to claim 1, wherein:
said user interface files are HTML files.

3. An interactive vacation destination selection system according to claim 1, wherein:
at least a plurality of said criteria each has a respective associated image file.

4. An interactive vacation destination selection system according to claim 3, wherein:
said image file associated with one of said criteria is changeable dependent upon the selection of another of said criteria.

5. An interactive vacation destination selection system according to claim 1, wherein:
said criteria are organized into categories, said categories including at least two from the group: destination, local area, accommodation, activities, suitability for children, and individual needs.

6. An interactive vacation destination selection system according to claim 1, wherein:
said user interface files include requests for input with respect to at least six of the following inquiries: the age ranges of travelers, when the user wants to travel, for how long the user wants to travel, how far away the use wants to travel, a budget range for the vacation, and a general type of vacation sought.

7. An interactive vacation destination selection system according to claim 1, wherein:
said user interface files include focus inquiries to focus a user on what the user wants to experience on a vacation.

8. An interactive vacation destination selection system according to claim 1, wherein:
said computer prepares a file collecting selected displayed vacation criteria and image files.

9. An interactive vacation destination selection system according to claim 1, wherein:
said recommendation of at least one vacation destination includes for each vacation destination at least four of: a photograph, a map, information about the destination, the weather of the destination, a hyperlink to additional information about the destination, recommended accommodations, prices, access, and availability.

10. An interactive vacation destination selection system according to claim 1, wherein:
said user interface files includes means for editing selected criteria such that the computer presents modified recommendations.

11. A method for selecting a vacation destination, comprising:
a) presenting to a user inquiries with respect to criteria for a vacation destination, none of said inquiries requesting the user to indicate where the user wants to vacation;
b) selecting a plurality of said criteria by the user;
c) determining from said selected plurality of criteria at least one recommended vacation destination for the user; and
d) outputting to said user said at least one recommended vacation destination.

12. A method according to claim 11, wherein:
said selecting includes selecting a general type of vacation.

13. A method according to claim 11, wherein:
said criteria each have an associated image file.

14. A method according to claim 13, wherein:
each said associated image file is a photographic image.

15. A method according to claim 13, wherein:
said presenting includes arranging said criteria and said associated image files in a two-dimensional array.

16. A method according to claim 11, further comprising:
e) after selecting, ranking a subset of said plurality of selected criteria.

17. A method according to claim 11, further comprising:
e) after selecting and prior to determining, providing to the user a display of said selected criteria and requesting the user to remove at least one of said criteria.

18. A method according to claim 11, further comprising:
e) after outputting, editing said selected criteria by the user.

19. A method according to claim 18, wherein:
said editing includes removing at least one of said selected criteria.

20. A method according to claim 11, wherein:
said output of said recommendation includes for each vacation destination at least four of: a photograph, a map, information about the destination, the weather of the destination, a hyperlink to additional information about the destination, recommended accommodations, prices, access, and availability.
